(19) United States
(12) Patent Application Publication
(10) Pub. No.: US 2014/0356613 A1
(43) Pub. Date: Dec. 4, 2014

(54) CARBON NANOTUBE STUDDED CARBON FIBER TOW AND MATRIX PREPREG

(71) Applicants: Materials Sciences Corporation, Horsham, PA (US); The University of Kentucky Research Foundation, Lexington, KY (US)

(72) Inventors: Matthew Collins Weisenberger, Georgetown, KY (US); John Davis Craddock, Lawrenceburg, KY (US); Richard Foedinger, Phoenixville, PA (US)

(73) Assignees: Materials Sciences Corporation, Horsham, PA (US); The University of Kentucky Research Foundation, Lexington, KY (US)

(21) Appl. No.: 13/906,410

(22) Filed: May 31, 2013

(51) Int. Cl. C09K 5/14; B32B 5/12

(52) U.S. Cl. CPC C09K 5/14; B32B 5/12
USPC 428/300.7; 252/71; 252/74; 252/76; 252/75; 427/248.1

(57) ABSTRACT

A carbon nanotube studded carbon fiber tow and matrix prepreg includes a body comprising a tow of surface fibers and interior bulk fibers. The surface fibers are studded with carbon nanotubes and the carbon fibers are infiltrated with a matrix material.

This invention was made with government support under contract no. W31P4Q-11-D-0078 awarded by the U.S. Army Contracting Command, Redstone Arsenal Alabama. The government has certain rights in the invention.

### TECHNICAL FIELD

The present invention generally relates to carbon fiber composite materials and more particularly to a carbon nanotube studded carbon fiber tow and matrix prepreg as well as to a method of making the same.

### BACKGROUND OF THE INVENTION

Carbon fiber composite materials are hugely attractive for lightweight, corrosion resistant structures. In particular, the aerospace industry is adopting carbon fiber composites, over traditional aluminum, at a rapid pace. The reason is simple. Reduced weight significantly improves and expands flight capabilities (and reduces fuel consumption). However, unlike isotropic aluminum structures, carbon fiber composite structures are largely fabricated from layers (or plies) of resin pre-impregnated (or prepreg) lamina, resulting in an anisotropic part; one in which the direction of the fiber axes is essentially excluded from orienting through the thickness of the part. Herein lies the problem. Although carbon fiber composites are structurally superior to aluminum on a per-weight basis, thermally they are not. The lack of continuity of carbon fibers through-structure-thickness and transverse-adjacent-fibers, sets up an insulating effect in that direction, which is detrimental to heat generating articles housed within carbon fiber structures. Specifically, electronics and avionics housed within carbon fiber airframes are particularly subject to overheat and failure.

To solve this parasitic thermal management problem, heat energy generated internally within the composite structure must ultimately be dissipated to the outside surroundings. This requires heat transfer through the thickness (the thermal bottleneck) of the structure. Fundamentally, the “bottleneck” is actually millions of carbon fiber—polymer matrix interfaces, across which heat conduction is significantly slowed in comparison to along the fiber axis (through thickness and transverse in-plane directions have such interfaces). This technology offers a solution to this problem by providing a pathway, via short dense carbon nanotubes grown on a significant fraction of the individual carbon fiber surfaces, through which heat can conduct across these interfaces (through-thickness and transverse in-plane fibers). The carbon nanotubes have extremely high thermal conductivities along their axes. With them oriented normal to the fiber surface, nanotubes, when compressed into composite structures, make inter-filament contact about the circumference of each filament, thus providing for the pathway of heat conduction, opening up this “bottleneck” of thermal transport.

### SUMMARY

A method is provided for making a carbon nanotube studded carbon fiber tow and matrix prepreg. That method may be broadly described as comprising the steps of: (a) applying a silicon containing material to a tow of carbon fibers to introduce a silicon-based coating on surfaces of the carbon fibers to support carbon nanotube growth, (b) growing carbon nanotubes on the surfaces of the carbon fibers using a chemical vapor deposition process and (c) infiltrating the tow of carbon fibers with a matrix material to produce the carbon nanotube studded, carbon fiber tow and matrix prepreg. The method may further include the step of selecting the silicon material from a group of materials consisting of a silicate, tetraethyl orthosilicate (TEOS), tetramethyl orthosilicate, tetrapropyl orthosilicate, polydimethylsiloxane (PDMS), a SiO₂ precursor and mixtures thereof. Further the method may include utilizing thermal decomposition of a catalyst/carbon feed source to grow the carbon nanotubes on the surfaces of the carbon fibers. The catalyst/carbon fiber feed source may be selected from a group of materials consisting of a transition metal catalyst, iron, cobalt, a carbon source, a hydrocarbon, an organometallic compound and mixtures thereof.

More specifically the method may include heating the catalyst/carbon feed source and the carbon fibers to a temperature of between 400° C. and 1,000° C. for a period of time of between 1 and 200 minutes. In some embodiments, this includes initiating the thermal decomposition from room temperature without any preheating. In some embodiments, this includes applying a silicon-based coating at room temperature without any preheating. In some embodiments, the method includes removing any sizing and chemical residue from the carbon fibers prior to applying the silicon-based coating. Further, in some embodiments the method includes increasing a percentage of surface fibers to interior bulk volume fibers comprising the carbon fiber tow prior to the sizing and chemical residue removal and silicon-based coating application steps.

In some embodiments the method includes selecting the polymer matrix material from a group of materials consisting of a thermoplastic resin, an epoxy resin, a vinyl ester, silicone, a cyanate ester, bismaleimide (BMI), a polyimide, a polyolefin, a polyurethane, a phenolic, an acrylic, a polyester, a carbonizable resin, polyfurfural, polycarbosilane, pitch, tar, rubber and mixtures thereof. Further the method may be completed in a continuous process or a batch process.

In some embodiments the method may include providing the carbon nanotube studded carbon fiber tow and matrix prepreg with 40 to 70 weight percent carbon fiber, 3 to 50 weight percent carbon nanotubes on the carbon fiber and approximately 30 to 60 weight percent matrix. In some embodiments the method includes using carbon fibers having a diameter of 5-10 microns. In some embodiments the method includes spreading the carbon fibers into a thin band of filaments so as to increase the percentage of surface fibers versus the percentage of interior bulk volume fibers in the carbon fiber tow. In some embodiments this includes providing the tow with between 10 and 50% surface fibers prior to applying silicon containing material to the tow.

In accordance with an additional aspect, a carbon nanotube studded carbon fiber tow and matrix prepreg is provided. That prepreg comprises a body having 40 to 70 weight percent carbon fibers, 3 to 50 weight percent carbon nanotubes on the carbon fiber and approximately 30 to 60 weight percent matrix. The carbon fibers, having a diameter of 5-10 microns, are spread into a thin band of filaments having a thickness of 10-1,000 microns and a width of 1-10 cm whereby the band has a thickness to individual filament diameter of 1-to-1 to 100-to-1 and the band includes between 3,000 and 50,000 filaments. In some embodiments the carbon nanotubes are 2-10 microns in length. In some embodiments, the carbon nanotubes are 2-3 microns in length. Multiple bands may be joined together in parallel to make a much wider product that may be subsequently prepregged.

In some embodiments the matrix is a polymer matrix made from a material selected from a group consisting of a thermoplastic resin, an epoxy resin, a vinyl ester, silicone, a cyanate ester, bismaleimide (BMI), a polyimide, a polyolefin, a polyurethane, a phenolic, an acrylic, a polyester, a carbonizable resin, polyfurfural, polycarbosilane, pitch, tar, rubber and mixtures thereof.

In some embodiments the matrix is a pre-ceramic matrix made from a material selected from a group consisting of polycarbosilane, polydimethylsiloxane and mixtures thereof.

In some embodiments the matrix is a metal matrix made from a material selected from a group consisting of aluminum, titanium, nickel, copper, their alloys and mixtures thereof.

In some embodiments the matrix is a pre-carbon matrix made from a material selected from a group consisting of coal tar, petroleum pitch, phenolic resin, epoxy, polyacrylonitrile, cellulosic polymers and mixtures thereof.

In some other embodiments the matrix is a carbon matrix made from a material selected from a group consisting of chemical vapor infiltration (CVI) of methane, natural gas, hydrocarbons and mixtures thereof.

In accordance with yet another aspect, a composite structure is provided comprising layers of the carbon nanotube studded spread tow carbon fiber matrix prepregs all compressed together to form a single integrated body.

### BRIEF DESCRIPTION OF THE DRAWINGS

The accompanying drawings incorporated herein and forming a part of the specification, illustrate several aspects of the carbon nanotube studded carbon fiber tow and matrix prepreg as well as the method of making the same and together with the description serve to explain certain principles thereof. In the drawings:

FIG. 1 is a schematical cross-sectional view of a carbon nanotube studded carbon fiber tow and matrix prepreg.

FIG. 2 is a schematical end view of a composite structure comprising layers of the carbon nanotube studded spread tow carbon fiber matrix prepreg illustrated in FIG. 1.

FIG. 3 is a schematical illustration of a continuous inline process for making the carbon nanotube studded carbon fiber tow and matrix prepreg illustrated in FIG. 1.

Reference will now be made in detail to the prepreg and method, examples of which are illustrated in the accompanying drawings.

### DETAILED DESCRIPTION

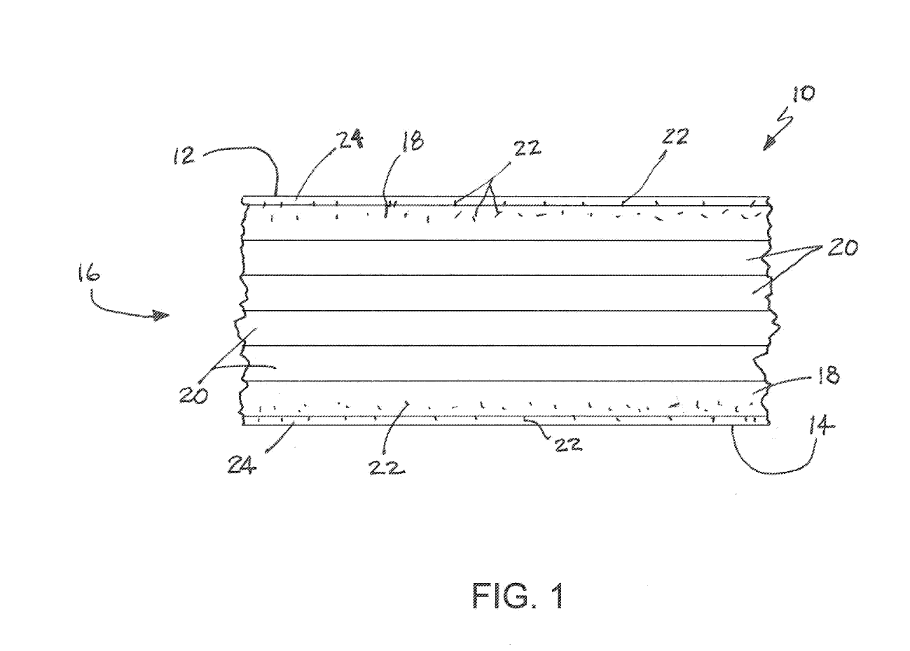

As best illustrated in FIG. 1, a carbon nanotube studded carbon fiber tow and matrix prepreg 10 has a body including a top face 12 and a bottom face 14. The body also includes a tow 16 of carbon fibers including surface fibers 18 and interior bulk fibers 20. Carbon nanotubes 22 are grown on the surfaces of the surface fibers. In addition the tow 16 of carbon fibers 18, 20 is infiltrated with a matrix material 24.

In one possible embodiment, the body of the prepreg 10 comprises 40-70 weight percent carbon fibers, 3 to 50 weight percent carbon nanotubes to carbon fiber and approximately 30 to 60 weight percent matrix material. The carbon fibers may, for example, have a diameter of 5-10 microns. These fibers may be spread into a thin band of filaments having a thickness of 10-1,000 microns and a width of 1-10 cm whereby the band has a thickness to individual filament diameter ratio of between 1-to-1 to 100-to-1 and the band includes between 3,000 and 50,000 filaments. The carbon nanotubes in some embodiments are 2-10 microns in length. In some embodiments the carbon nanotubes are 2-5 microns in length. In yet other possible embodiments the carbon nanotubes are 2-3 microns in length. In some embodiments multiple bands are joined together in parallel and subsequently prepregged in order to make a wider product appropriate for use for any particular application. The bands may be joined by guiding them into adjacent bands, and processing them in parallel.

In some embodiments the matrix 24 is a polymer matrix made from a material selected from a group consisting of thermoplastic resin, an epoxy resin, a vinyl ester, silicone, a cyanate ester, bismaleimide (BMI), a polyimide, a polyolefin, a polyurethane, a phenolic, an acrylic, a polyester, a carbonizable resin, polyfurfural, pitch, tar, rubber and mixtures thereof. In some embodiments the matrix 24 is a pre-ceramic matrix made from a material selected from a group consisting of polycarbosilane, polydimethylsiloxane and mixtures thereof.

In some embodiments the matrix 24 is a metal matrix made from a material selected from a group consisting of aluminum, titanium, nickel, copper, their alloys and mixtures thereof.

In some embodiments the matrix 24 is a pre-carbon matrix made from a material selected from a group consisting of coal tar, petroleum pitch, phenolic resin, epoxy, polyacrylonitrile, cellulosic polymers and mixtures thereof.

In some embodiments the matrix 24 is a carbon matrix made from a material selected from a group consisting of chemical vapor infiltration (CVI) of methane, natural gas, hydrocarbons and mixtures thereof.

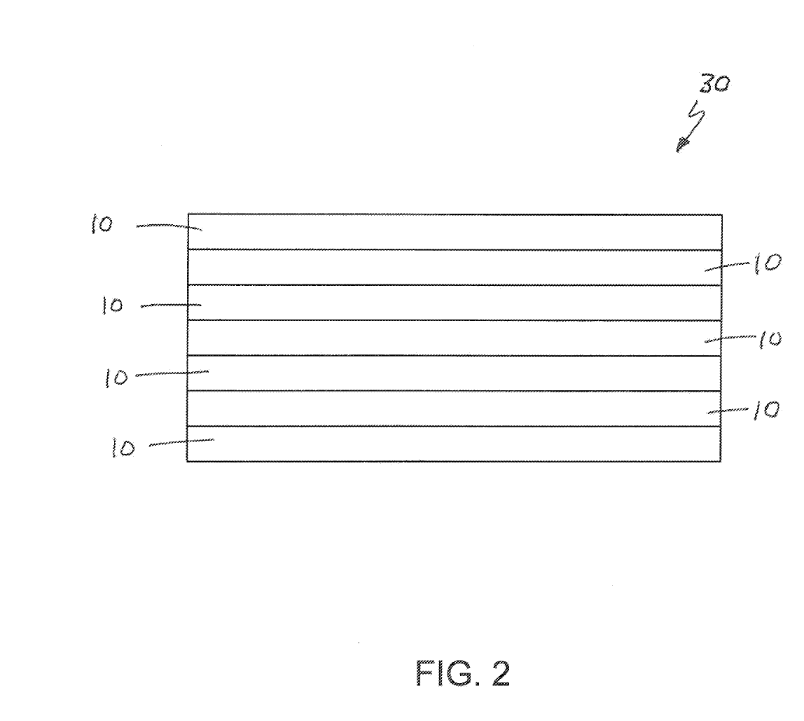

FIG. 2 illustrates a composite structure 30 which comprises multiple layers of carbon nanotube studded spread tow carbon fiber matrix prepregs 10 of the type illustrated in FIG. 1 all compressed together into a single structural body. In some embodiments the filaments of the carbon fiber tows in adjacent layers of the composite structure 30 run perpendicular to one another. In other possible embodiments, the carbon fiber filaments in adjacent layers run at an angle or approximately 45° with respect to one another. In another possible embodiment the carbon fiber filaments in adjacent layers run parallel or unidirectional with respect to one another.

A method of making the carbon nanotube studded carbon fiber tow and matrix prepreg 10 will now be described. The method may be said to broadly include the steps of: (1) applying a silicon containing material to a tow of carbon fibers to introduce a silicon containing coating on exposed surfaces of the carbon fibers to support carbon nanotube growth, (2) growing carbon nanotubes on the exposed surfaces of the carbon fibers using a chemical vapor deposition process and (3) infiltrating the tow of carbon fibers with a matrix material to produce the carbon nanotube studded carbon fiber tow and matrix prepreg 10. This silicon containing material is applied to the carbon fibers in order to support enhanced nanotube growth. Silicon containing materials suitable for this purpose include but are not limited to tetraethyl orthosilicate (TEOS), tetramethyl orthosilicate, tetrapropyl orthosilicate, polydimethylsiloxane, a SiO₂ precursor and mixtures thereof.

The carbon nanotubes may be grown on the surfaces of the carbon fibers by a chemical vapor deposition process such as that disclosed in U.S. Pat. Nos. 7,160,531 and 7,504,078 both to Jacques et al. Thus, the method may be broadly described as utilizing thermal decomposition of a catalyst/carbon feed source to grow the carbon nanotubes on the surface of the carbon fibers. The catalyst/carbon feed source may be selected from a group of materials consisting of a transition metal catalyst, iron, cobalt, a carbon source, a hydrocarbon, an organometallic compound and mixtures thereof. More specifically, the method includes heating the catalyst/carbon feed source and the carbon fibers to a temperature of between 400° C. and 1,000° C. for a period of time of between 1 and 200 minutes.

In accordance with some embodiments of the method, the silicon containing material may be applied at room temperature without any pre-heating. Further, the subsequent CVD CNT studding process can be initiated from room temperature without any preheating step of the silicon containing material coating the carbon fibers. It is not necessary to soften the fibers prior to chemical vapor deposition. Advantageously this reduces production costs and production time and thus is a significant benefit over prior art approaches that, for example, utilize an electric field to generate a carbon plasma as set forth in U.S. Pat. No. 8,158,217 to Shaw et al.

Where the carbon fiber tow starting material includes sizing and chemical residue, some embodiments of the method include removing any sizing and chemical residue from the carbon fibers prior to applying a silicon containing material.

In some embodiments, the method includes increasing a percentage of surface fibers to interior, bulk volume fibers comprising the carbon fiber tow prior to the sizing and chemical residue removal and/or silicon containing material application steps. This may be accomplished by spreading the carbon fibers into a thin band of filaments so as to increase the percentage of surface fibers versus the percentage of interior bulk fibers in the carbon fiber tow. Preferably the tow is spread so as to provide between 10% and 50% surface fibers prior to applying silicon containing material to the tow.

Since a chemical vapor deposition process is utilized to grow the short multi-wall carbon nanotubes from the surfaces of the carbon fibers, the interior bulk fibers of the tow are shadowed from nanotube growth by the surface fibers. By increasing the percentage of surface fibers to bulk interior or volume fibers, it is possible to grow nanotubes on as many carbon filaments in the tow as possible. This may be done by (1) spreading the tow into a ribbon or band of minimal overall thickness relative to individual filament diameter or (2) by using very small filament count tows. Both will have higher percent surface fibers-to-volume fibers as expressed by the formulas below:

For a spread tow: %(surface fibers)-to-(volume fibers).

%(surface fibers)-to-(volume fibers)=100%×[(2×filament diameter)/(spread tow thickness)].

(That is, 2 filaments—the upper and lower faces—would be exposed to the chemical vapor deposition process, while the remaining filaments would be shadowed within the bulk interior of the spread tow)

As an example, a 20 mm wide spread tow has an individual filament diameter of 5 micron. The spread tow has a 120 micron tow thickness. Therefore the % (surface fibers)-to-(volume fibers)=8.3% (surface fibers)-to-(volume fibers). (So theoretically, the tow is 24 fibers thick, with 2 of those fibers exposed (top and bottom face)−making for 8.3% surface filaments to volume filaments).

For a very small-filament-count tow: %(surface fibers)-to-(volume fibers).

%(surface fibers)-to-(volume fibers)=100%×[C/T]

Where C=the number of filaments required to complete a perimeter of the small-count tow, and T is the total number of filaments in the small-count tow.

Given that the total area of the tow (A)=(pi/4*d̂2)×T, where d=the diameter of an individual filament, this “effective area” (A) of the small-count tow can be approximated by a circle of that area. From (A) the perimeter of the small-count tow can be calculated from its diameter.

P=pi×sqrt[(4A/pi)]

And

C=P/d

The following examples further illustrate the method of making the carbon nanotube studded carbon fiber tow and matrix prepreg 10.

### Example 1

A “small count tow” has 333 filaments and each filament has a diameter of about 10 microns. So in a tow form, this “small count tow” would have an area of pi/4*d̂2*333=26154 sq. micron.

A “circle” of this area would have a diameter of: 182.5 micron. This would be the approximate diameter of the “small count tow”. So, its circumference would be pi×D=573 micron.

“Lining up” filaments to make up this circumference would be 573/10=57 filaments. 57 filaments of the original 333 would be “surface filaments”. So the “small count tow” would be 57/333×100%=17% (surface fibers)-to-(volume fibers).

Significantly, multiple, parallel small count tow carbon fiber of the type described may be (1) de-sized (if necessary), (2) coated with a silicon containing material (3) CNT studded and then combined to form a larger count tow while preserving the high surface fiber-to-volume fiber ratio. For example 36-333 count tows may be run in parallel and recombined into a 12,000 count tow.

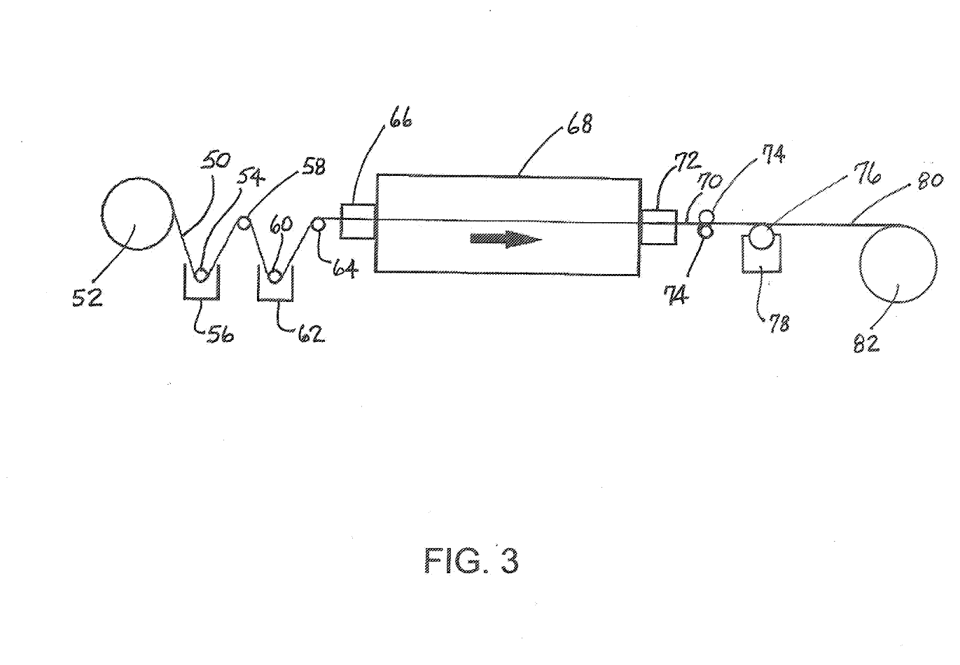

Reference is now made to FIG. 3 illustrating a method of processing the prepreg 10 in a continuous inline manner. As illustrated a spread carbon fiber tow 50 is unwound from a braked pay-off spool 52 and fed over an idler roller 54 through an acetone bath 56. This functions to remove any sizing and chemical residue from the carbon fibers of the tow 50. The tow 50 is then fed over the idler roller 58 to the idler roller 60 to a silicon containing material applicator 62 where a silicon containing material such as tetraethyl orthosilicate is applied to the surfaces of the carbon fibers in the tow including, particularly, the surface fibers. The tow is then fed over the idler roller 64 through an inert gas purge curtain 66 (e.g. nitrogen) into a chemical vapor deposition reactor 68 where carbon nanotubes are grown on the silicon treated surfaces of the carbon fibers by means of chemical vapor deposition. The carbon nanotube studded carbon fiber tow 70 is then fed through a second inert gas curtain 72 and the idler rollers 74. Next, the carbon nanotube studded carbon fiber tow 70 engages a kiss roller 76. The kiss roller 76 applies matrix material from the matrix bath 78. This matrix material infiltrates or wets the tow producing a matrix impregnated nanotube studded carbon fiber tow 80 which is subsequently taken up on the take up reel 82. Alternatively the emerging carbon nanotube studded tow 70 can be guided to, and sandwiched between an upper and lower, pre-filmed-matrix filmed on release backer material. Subsequently the sandwich is routed through nip-rollers to heat and compress the matrix film(s) into the sandwiched carbon nanotube studded tow. Lastly this is rolled up on a cylindrical core as the prepreg material.

### Example 2

A spread tow of carbon fiber was dipped through an acetone bath to remove sizing and other soluble coatings or additions. A pre-spread tow can be used, or the tow can be spread utilizing standard tow spreading equipment prior to the acetone bath. Subsequently, the tow was dipped in a tetraethylorthosilicate (TEOS) bath, which wetted the tow. This spread tow was then introduced through an inert gas purge box and through a chemical vapor deposition process known to grow multiwall carbon nanotubes (MWCNT). The emerging, MWCNT-studded spread carbon fiber tow was then run through an exit inert gas purge box, and routed over a kiss-roller, wetting out the MWCNT-studded spread carbon fiber tow with an epoxy resin matrix. The epoxy impregnated, MWCNT-studded spread carbon fiber tow was then taken up, between upper and lower release films, and wound on a cylindrical core. Sections of this epoxy impregnated MWCNT-studded spread carbon fiber tow were then cut and hand laid-up in a sequence of plies such that fibers in adjacent plies were perpendicular in-plane with respect to each other, or in a 0-90 lay-up. This was composed of 16 layers or plies. This composite was then vacuum bag cured. Subsequent thermal testing showed improvements to the through thickness thermal diffusivity of 57%, while the thickness of this composite was only 20% thicker than an identically fabricated sample without any MWCNT studding process.

### Example 3

A spread tow of carbon fiber was dipped through an acetone bath to remove sizing and other soluble coatings or additions. A pre-spread tow can be used, or the tow can be spread utilizing standard tow spreading equipment prior to the acetone bath. Subsequently, the tow was dipped in a tetraethylorthosilicate (TEOS) bath, which wetted the tow. This spread tow was then introduced through an inert gas purge box and through a heated zone to convert the TEOS to SiO₂. The emerging tow is then run through a chemical vapor deposition process known to grow multiwall carbon nanotubes (MWCNT), and wound up.

### Example 4

A spread tow of MWCNT-studded carbon fiber is formed as described in Example 1. Upon exit from the CVD MWCNT deposition process, the tow is sandwiched between pre-filmed matrix material on release backer material through a series of nip-rollers under controlled conditions (temperature, gap distance). This infiltrates a precise amount of matrix material into the spread tow of MWCNT-studded carbon fiber. This prepreg can then be wound up and stored for subsequent composite fabrication.

### Example 5

Instead of a spread tow, as described in Example 1, a plurality of small-count carbon fiber tows are run in parallel through the process. The small-count tows (less than 3000 filaments), can provide high surface fiber-to-volume fiber ratios as shown above. Subsequent to the CVD MWCNT studding process, the plurality of small-count carbon fiber tows are recombined into a larger tow and subsequently processed for matrix infiltration as described in examples 2 or 4.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A method of making a carbon nanotube studded carbon fiber tow and matrix prepreg, comprising:
applying a silicon containing material to a tow of carbon fibers to introduce a silicon containing coating on surfaces of said carbon fibers to support carbon nanotube growth;
growing carbon nanotubes on said surfaces of said carbon fibers using a chemical vapor deposition process; and
infiltrating said tow of carbon fibers with a matrix material to produce said carbon nanotube studded carbon fiber tow and matrix prepreg.

2. The method of claim 1, including selecting said silicon-containing material from a group of materials consisting of a silicate, tetraethyl orthosilicate (TEOS), tetramethyl orthosilicate, tetrapropyl orthosilicate, polydimethylsiloxane, any SiO₂ precursor and mixtures thereof.

3. The method of claim 1 including utilizing thermal decomposition of a catalyst/carbon feed source to grow said carbon nanotubes on said surfaces of said carbon fibers.

4. The method of claim 3, including selecting said catalyst/carbon feed source from a group of materials consisting of a transition metal catalyst, iron, cobalt, a carbon source, a hydrocarbon, an organometallic compound and mixtures thereof.

5. The method of claim 3, including heating said catalyst/carbon feed source and said carbon fibers to a temperature of between 400° C. and 1,000° C. for a period of time of between 1 and 200 minutes.

6. The method of claim 1, including completing said applying of silicon-containing material at room temperature without any preheating.

7. The method of claim 1, including removing any sizing and chemical residue from said carbon fibers prior to applying said silicon containing material.

8. The method of claim 1, including increasing a percentage of surface fibers to interior, bulk volume fibers comprising the carbon fiber tow.

9. The method of claim 1, including selecting said polymer matrix material from a group of materials consisting of a thermoplastic resin, an epoxy resin, a vinyl ester, silicone, a cyanate ester, bismaleimide (BMI), a polyimide, a polyolefin, a polyurethane, a phenolic, an acrylic, a polyester, a carbonizable resin, polyfurfural, pitch, tar, rubber and mixtures thereof.

10. The method of claim 1, including completing said method as a continuous process.

11. The method of claim 1, including providing said carbon nanotube studded carbon fiber tow and matrix prepreg with 40 to 70 weight percent carbon fiber, 3 to 50 weight percent carbon nanotubes to carbon fiber and 30 to 60 weight percent polymer matrix.

12. The method of claim 1 including using carbon fibers having a diameter of 5-10 microns.

13. The method of claim 1, including spreading said carbon fibers into a thin band of filaments so as to increase the percentage of surface fibers versus the percentage of interior bulk volume fibers in said carbon fiber tow.

14. The method of claim 13 including providing said tow with between 10 and 50% surface fibers prior to applying silicon containing material to said tow.

15. A carbon nanotube studded carbon fiber tow and matrix prepreg, comprising:
a body having 40 to 70 weight percent carbon fiber, 3 to 50 weight percent carbon nanotubes to carbon fiber and 30 to 60 weight percent matrix, said carbon fibers having a diameter of 5-10 microns spread into a thin band of filaments having a thickness of 10-1,000 microns and a width of 1-10 cm whereby said band has a thickness to individual filament diameter of 1-to-1 to 100-to-1 and said band includes between 3,000 and 50,000 filaments.

16. The prepreg of claim 15 wherein said carbon nanotubes are 2-10 microns in length.

17. The prepreg of claim 15, wherein said carbon nanotubes are 2-3 microns in length.

18. The prepreg of claim 15, wherein said matrix is a polymer matrix made from a material selected from a group consisting of a thermoplastic resin, an epoxy resin, a vinyl ester, silicone, a cyanate ester, bismaleimide (BMI), a polyimide, a polyolefin, a polyurethane, a phenolic, an acrylic, a polyester, a carbonizable resin, polyfurfural, pitch, tar, rubber and mixtures thereof.

19. The prepreg of claim 15, wherein said matrix is a pre-ceramic matrix made from a material selected from a group consisting of polycarbosilane, polydimethylsiloxane and mixtures thereof.

20. The prepreg of claim 15, wherein said matrix is a metal matrix made from a material selected from a group consisting of aluminum, titanium, nickel, copper, their alloys and mixtures thereof.

21. The prepreg of claim 15, wherein said matrix is a pre-carbon matrix made from a material selected from a group consisting of coal tar or petroleum pitch, phenolic resin, epoxy, polyacrylonitrile, cellulosic polymers and mixtures thereof.

22. The prepreg of claim 15, wherein said matrix is a carbon matrix made from a material selected from a group consisting of chemical vapor infiltration (CVI) of methane, natural gas, hydrocarbons and mixtures thereof.

23. A composite structure comprising layers of said carbon nanotube studded spread tow carbon fiber matrix prepregs as set forth in claim 15 compressed together.

24. A method of making a carbon nanotube studded carbon fiber tow and matrix prepreg, comprising:
(a) increasing percentage of surface fibers to interior, bulk volume fibers comprising a small count carbon fiber tow with a fiber count of between 10 and 3000 fibers;
(b) applying a silicon containing material to said small count carbon fiber tow to introduce a silicon containing coating on surfaces of said carbon fibers to support carbon nanotube growth;
(c) growing carbon nanotubes on said surfaces of said carbon fibers using a chemical vapor deposition process to prepare a plurality of parallel small count carbon fiber tows;
(d) joining said multiple small count carbon fiber tows in parallel; and
(e) infiltrating said joined tow of carbon fibers with matrix material to produce said carbon nanotube studded carbon fiber tow and matrix prepreg.
